(19) United States
(12) Patent Application Publication
(10) Pub. No.: US 2014/0251213 A1
(43) Pub. Date: Sep. 11, 2014

(54) DEVICE FOR ASSEMBLING OPTICAL CONNECTOR

(71) Applicant: HON HAI PRECISION INDUSTRY CO., LTD., New Taipei (TW)

(72) Inventor: CHIH-CHEN LAI, New Taipei (TW)

(73) Assignee: HON HAI PRECISION INDUSTRY CO., LTD., New Taipei (TW)

(21) Appl. No.: 13/968,428

(22) Filed: Aug. 16, 2013

(30) Foreign Application Priority Data
Mar. 7, 2013 (TW) 102108139

(51) Int. Cl. B05B 12/08

(52) U.S. Cl. CPC B05B 12/082
USPC 118/669

(57) ABSTRACT

A device includes an ejector, a driver, a camera module, and a processing unit. The ejector is movably arranged above a printed circuit board of an optical connector and stores adhesive. The driver connects with the ejector and drives the ejector to move to aim at predetermined points on the printed circuit board and to eject of a drop of the adhesive to each point. The camera module is arranged above the printed circuit board and captures images of each drop of the adhesive. The processing unit is in communication with the camera module and the driver and processes the images of each drop of the adhesive to determine if an amount of the adhesive applied to the corresponding point is appropriate, and, if yes, signals the driver to drive the ejector to stop ejecting and move to aim at a next point.

### BACKGROUND

1. Technical Field

The present disclosure relates to optical connectors and, particularly, to a device to assemble an optical connector.

2. Description of Related Art

Optical connectors include a printed circuit board, a photoelectric element, and a lens element. The photoelectric element is positioned on and is electrically connected to the printed circuit board. The lens element includes a lens and is also positioned on the printed circuit board. The lens element covers the photoelectric element and the lens is required to be aligned with the photoelectric element to ensure quality. However, the lens element is typically secured to the printed circuit board using adhesive, which may not be uniformly applied and causes the lens to misalign with the photoelectric element.

Therefore, it is desirable to provide a device for assembling an optical connector that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric view of a device for assembling an optical connector, according to an embodiment.

FIG. 2 is a functional block diagram of the device of FIG. 1.

### DETAILED DESCRIPTION

Embodiments of the present disclosure will be described with reference to the drawings.

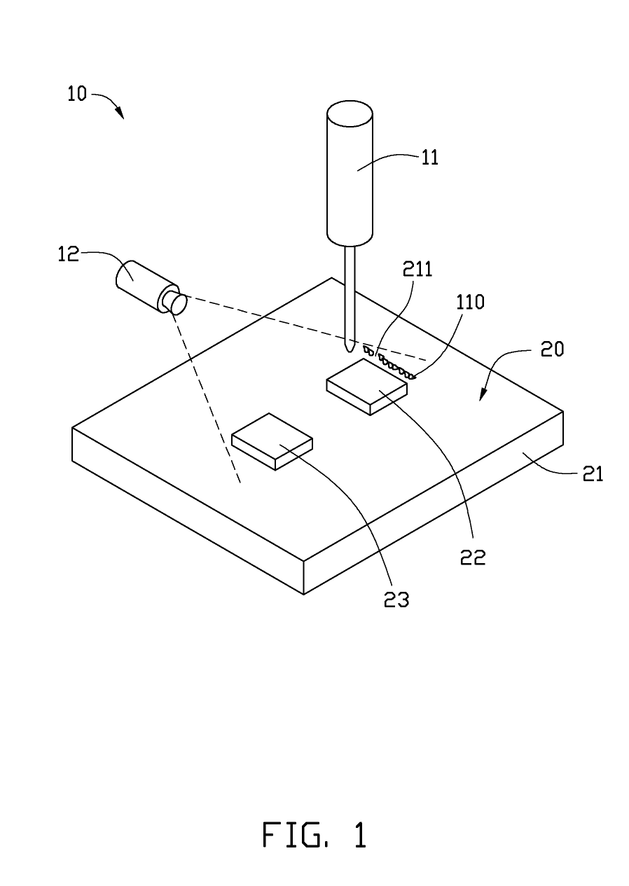

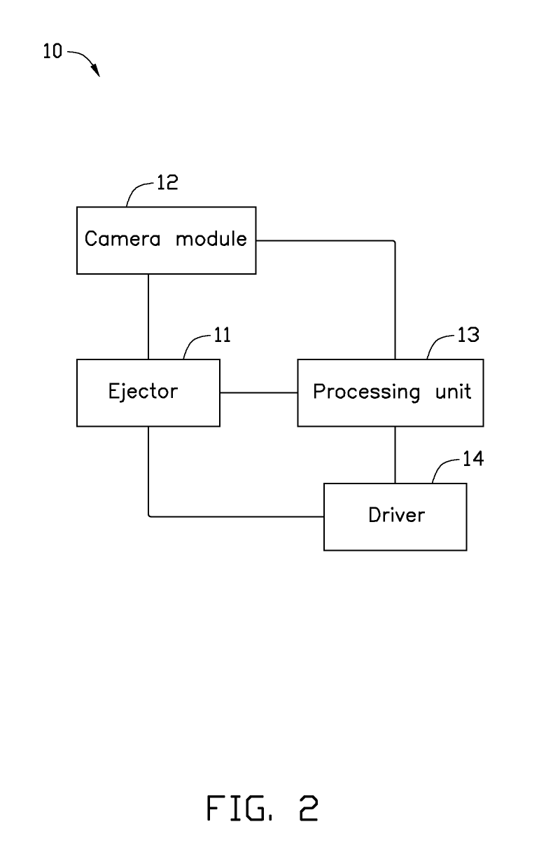

FIGS. 1 and 2 show a device 10 for assembling an optical connector 20. In particular, the device 10 is for applying adhesive 110 onto a printed circuit board 21 of the optical connector 20. The optical connector 20 also includes two photoelectric elements 22, 23. The photoelectric elements 22, 23 can be light emitters, such as light emitting diodes and laser diodes, or light receivers, such as photo diode. In this embodiment, the photoelectric element 22 is the light emitter and the photoelectric element 23 is the light receiver. In other embodiments, only one or more than two photoelectric elements can be employed depending on needs. The optical connector 20 may also include a lens element (not shown). The adhesive 110 is for securing the lens element on the printed circuit board 21 such that the lens element covers the photoelectric elements 22, 23. As such, it is required that the adhesive 110 surrounds the photoelectric element 22, 23.

The device 10 includes an adhesive ejector 11, a camera module 12, a processing unit 13, and a driver 14.

The ejector 11, such as a syringe, is positioned above the printed circuit board 21 and stores the adhesive 110. The ejector 11 is moved by the driver 14 to aim at a number of predetermined points 211 on the printed circuit board 21. The points 211 surround the photoelectric element 22, 23. The ejector 11, under control of the driver 14, ejects a drop of the adhesive 110 at each point 211.

The camera module 12 is positioned above the printed circuit board 21 and captures consecutive images of each drop of the adhesive 110. The camera module 12 can be charge-coupled device (CCD) based or complementary metal-oxide semiconductor (CMOS) based.

The processing unit 13 is in communication with the camera module 12 and processes the images to determine if an amount of each drop of the adhesive 110 is appropriate. In particular, the processing unit 13 stores a predetermined shape. The processing unit 12 recognizes a shape of each drop of the adhesive 110 by processing the images and compares the recognized shape with the predetermined shape. If the shapes are substantially identical, the amount of the drop of the adhesive 110 is appropriate.

The driver 14 is in communication with the processing unit 13 and connects with the ejector 11. The driver 14 drives the ejector 11 to move to aim at the points 211 in sequence. After the ejector 11 aims at each point 211, the driver 14 drives the ejector 11 to continuously eject the adhesive to the point 211 until the shape of the adhesive 110 accumulated at the point 211 is determined to be substantially identical to the predetermined shape. Then, the driver 14 drives the ejector 11 to stop ejecting and to move to aim a new point 211.

As such, the adhesive 110 can be uniformly applied and alignment between lenses of the lens element and the photoelectric elements 22, 23 can be achieved.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A device for assembling an optical connector, comprising:
an ejector movably arranged above a printed circuit board of the optical connector and storing adhesive;
a driver connecting with the ejector and configured to drive the ejector to move to aim at a plurality of predetermined points on the printed circuit board, the driver also being configured to drive the ejector to eject of a drop of the adhesive to each point after the ejector aims at the point;
a camera module arranged above the printed circuit board and configured to capture a plurality of images of each drop of the adhesive; and
a processing unit in communication with the camera module and the driver, the processing unit being configured to processing the images of each drop of the adhesive to determine if an amount of the adhesive applied to the corresponding point is appropriate, the processing unit also being configured to signal the driver to drive the ejector to stop ejecting and move to aim at a next point.

2. The device of claim 1, wherein the ejector is a syringe.

3. The device of claim 1, wherein the camera module is CCD-based or CMOS-based.

4. The device of claim 1, wherein the processing unit is configured to store a predetermined shape, recognize the shape of the drop of the adhesive by processing the images, and compare the recognized shape with the predetermined shape, and the processing unit determines that the amount of the drop of the adhesive is appropriate when the shapes are substantially identical.
